(19) United States
(12) Patent Application Publication
(10) Pub. No.: US 2026/0268355 A1
(43) Pub. Date: Sep. 10, 2026

(54) POWER PARK

(71) Applicant: HL Energy Ventures, Dallas, TX (US)

(72) Inventors: Victor K. Liu, Richardson, TX (US); Robert D. Maher, III, Frisco, TX (US); Michael D. Maher, Frisco, TX (US); Mark H. Griffin, Dallas, TX (US); Robert W. England, Flower Mound, TX (US)

(21) Appl. No.: 19/559,514

(22) Filed: Mar. 6, 2026

Related U.S. Application Data
(60) Provisional application No. 63/768,079, filed on Mar. 6, 2025.

(51) Int. Cl. G06Q 30/0202; G06Q 30/0201; G06Q 50/06

(52) U.S. Cl. CPC G06Q 30/0202; G06Q 30/0206; G06Q 50/06

(57) ABSTRACT

Particular example embodiments described herein can provide for a system, an apparatus, and a method to help enable a power park. In an example, the system, apparatus, and method can create energy in a power park and/or receive energy by the power park, receive energy market data and performance contract parameters, determine energy distribution requirements within the power park, and distribute or sell available energy not required by the power park.

### CROSS-REFERENCE TO RELATED APPLICATION

This application claims priority to Provisional Application No. 63/768,079, entitled “POWER PARK” filed in the United States Patent Office on Mar. 6, 2025, which is hereby incorporated by reference in its entirety.

### TECHNICAL FIELD

This disclosure relates in general to the field of energy, energy generation, and/or energy storage and, more particularly, to a system, an apparatus, a method, and means to help enable a power park.

### BACKGROUND

The expected hyper growth of AI and corresponding data centers represents a market discontinuity in the power industry. The US Department of Energy estimates that US datacenter electricity consumption as a percentage of total US power consumed could nearly triple in just five years, from 4.4% in 2023 to 12% by 2028.

While renewable generation has also grown significantly, the intermittent nature of solar and wind power generation does not satisfy the constant, high-capacity need of large data centers that require always-on, firm and reliable power. Purchasing renewable offsets or funding renewable power generation projects in areas different from the data center load demand maybe benefit public perception and relations, but it can exacerbate load balancing and grid instability problems.

In some locations, especially those with explosive data center growth, power prices often reflect power supply-demand imbalances and transmission constraints, such that periods of power over-abundance, such as those in high wind resourced areas, can result in negative electricity pricing, while at other times, a dearth of power can lead to price surges of hundreds of dollars per kWh.

In some areas with the impending data center growth, policymakers are debating whether large data centers are to provide their own on-site generation. While such growth represents a significant opportunity for AI, power, energy, and infrastructure capital companies, it also represents a significant challenge for these companies, and many others from mitigating climate change to managing extremely high capital, infrastructure risk.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a power park, in accordance with an embodiment of the present disclosure;

FIG. 2 is a simplified block diagram of a particular implementation of a power park control system, in accordance with an embodiment of the present disclosure;

FIG. 3 is a simplified block diagram illustrating example details of a particular implementation of a power park control system engine in a power park, in accordance with an embodiment of the present disclosure;

FIG. 4 is a simplified block diagram illustrating examples details of a particular implementation of a plurality of power parks, in accordance with an embodiment of the present disclosure;

FIG. 5 is a simplified flowchart illustrating potential operations to help enable the power park, in accordance with an embodiment of the present disclosure;

FIG. 6 is a simplified block diagram illustrating example details of an example computer model inference and computer model training to help enable the determined energy distribution within the power park and if power can be resold, in accordance with an embodiment of the present disclosure; and

FIG. 7 is a simplified block diagram illustrating examples details of an example neural network architecture to enable the determined energy distribution within the power park and if power can be resold, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems to help enable a power park, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In some examples, a power park can include a plurality of loads (datacenters, power to liquid industrial complexes with electrolyzers, fuel cells, etc.), an energy generation source (solar, wind, natural gas with carbon capture and sequestration, small modular nuclear reactor, geothermal power plant, etc.), an optional energy storage device (battery), an electrical grid interface, and geographical proximity to essential infrastructure including a plurality of natural gas pipelines, fiber for network communications, and CO₂ pipeline for carbon sequestration (CO₂ storage, enhanced oil recovery, etc.). The power park can also include a control system that receives energy market data (current and future pricing, weather forecasts, etc.), monitors and manages various generation sources, monitors carbon credits, renewable energy credits, and regulates the flow of energy via an electrical substation from the plurality of generations sources and or an external electrical power grid to supply low carbon intensity, reliable power to the plurality of loads. The power park seeks to create a platform that motivates the growth for dispatchable firm power that would be low-carbon intensity, as well as the continued growth of renewable energy generation, and grid stability. In creating this dynamic, the power park would supplement the data center with additional but complementary industrial load customers who value green, renewable power generation.

### Example Systems, Apparatuses, and Methods

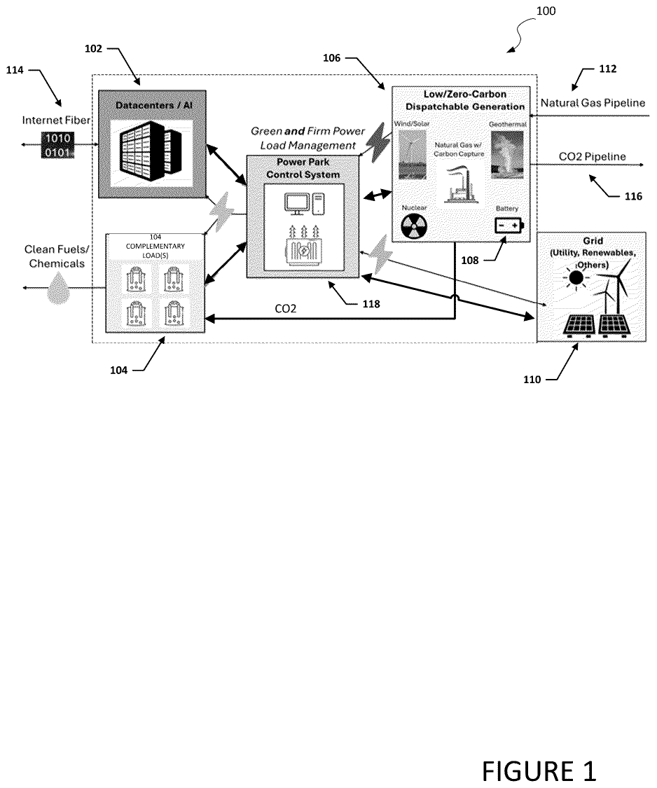

FIG. 1 is simplified block diagram of a particular non-limiting power park 100. The power park can include a plurality of loads (datacenters, bitcoin mining, power to liquid industrial complexes with electrolyzers, fuel cells, etc.) 102, complementary load(s) 104, an energy generation source (solar, wind, natural gas with carbon capture and sequestration, small modular nuclear reactor, geothermal power plant, etc.) 106, an optional energy storage device (battery) 108, an electrical grid interface 110, and geographical proximity to infrastructure including a plurality of natural gas pipelines 112, fiber for network communications 114, CO₂ pipeline 116 for carbon sequestration (CO₂ storage, enhanced oil recovery, etc.) and other infrastructure. The power park 100 also includes a control system 118. The control system 118 can be configured to receive energy market data (current and future pricing, weather forecasts, etc.), monitor and manage various generation sources, and regulate the flow of energy via an electrical substation from the plurality of generations sources and or an external electrical power grid to supply low carbon intensity, reliable power to the plurality of loads. Power can be pulled from the electric grid interface 110 when needed and/or to lower carbon intensity scores. The complementary load(s) 104 can include power to liquids, fuel cells, etc. The complementary load(s) 104 can be configured to generate power for sale or usage within the power park 100 or outside the power park 100 through the electrical grid interface 110.

In some embodiments, the optional energy storage device 108 may include various types of energy storage technologies beyond batteries. For example, the optional energy storage device 108 may include lithium-ion batteries, flow batteries such as vanadium redox or zinc-bromine batteries, compressed air energy storage systems, pumped hydroelectric storage, flywheels, or other energy storage technologies. The optional energy storage device 108 may be configured to store excess energy generated by the energy generation source 106 when generation exceeds demand, and to discharge stored energy when demand exceeds generation or when energy prices are favorable for discharge. In some examples, the optional energy storage device 108 may provide backup power to maintain reliability during interruptions in generation or grid supply, load balancing to smooth variations in renewable energy generation, frequency regulation services to support grid stability, and peak shaving to reduce demand charges or avoid high-price periods. The power park control system engine 210 may monitor the state of charge, available capacity, charge and discharge rates, and operational status of the optional energy storage device 108 to optimize its utilization within the power park 100.

In some embodiments, the electrical grid interface 110 may enable bidirectional power flow between the power park 100 and an external electrical power grid. The electrical grid interface 110 may include various components such as transformers for voltage conversion, switchgear for circuit protection and isolation, protective relays for fault detection and response, metering equipment for measuring power flows, and power electronics for power conditioning and conversion. The electrical grid interface 110 may be configured to import power from the external electrical power grid when the power park 100 requires additional power beyond its internal generation capacity, or when grid power is less expensive or has lower carbon intensity than internal generation. The electrical grid interface 110 may also be configured to export power to the external electrical power grid when the power park 100 has excess generation capacity, when grid power prices are favorable for export, or when the grid operator requests ancillary services such as frequency regulation or spinning reserves. In some examples, the electrical grid interface 110 may comply with interconnection standards and grid codes that specify technical requirements for connecting to the external electrical power grid, including power quality, protection coordination, and communication protocols.

In some embodiments, the electrical grid interface 110 may provide various ancillary services to support the stability and reliability of the external electrical power grid. Ancillary services may include frequency regulation, in which the power park 100 adjusts its power output or consumption in response to deviations in grid frequency from its nominal value, helping to maintain the balance between generation and load across the grid. Ancillary services may also include spinning reserves, in which the power park 100 maintains generation capacity that is synchronized to the grid and ready to respond within a short time period, (e.g., ten minutes, 20 minutes, etc.), to compensate for unexpected generation outages or load increases. Additional ancillary services may include voltage support, in which the power park 100 provides reactive power to maintain voltage levels within acceptable ranges, and black start capability, in which the power park 100 can restart without external power to help restore the grid after a widespread outage. The power park control system engine 210 may coordinate the provision of ancillary services through the electrical grid interface 110 based on grid operator requests, market prices for ancillary services, and the operational status of the power park 100 components.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure.

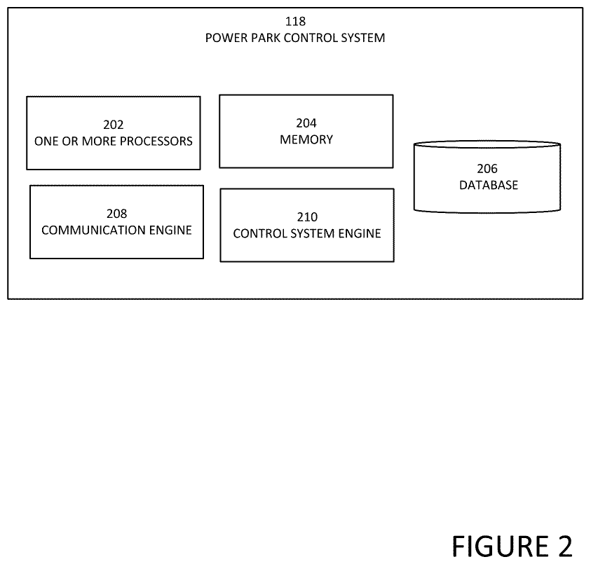

Turning to FIG. 2, FIG. 2 is a simplified block diagram illustrating example details of a particular non-limiting illustrative example of the control system 118. The control system 118 can include one or more processors 202, memory 204, database storage 206, a communication engine 208, and a power park control system engine 210. In some embodiments, the processors 202 may be communicatively coupled to the memory 204, the database storage 206, the communication engine 208, and the power park control system engine 210. The memory 204 may store instructions executable by the processors 202 to implement the functionality of the control system 118. The database storage 206 may be configured to store operational data, historical data, and configuration parameters used by the power park control system engine 210. The communication engine 208 may facilitate data exchange between the control system 118 and external systems, including energy market data providers, grid operators, and the various components of the power park 100. The power park control system engine 210 may utilize data from the database storage 206 and the communication engine 208, and may execute on the processors 202 using instructions stored in the memory 204, to determine and implement energy distribution decisions for the power park 100.

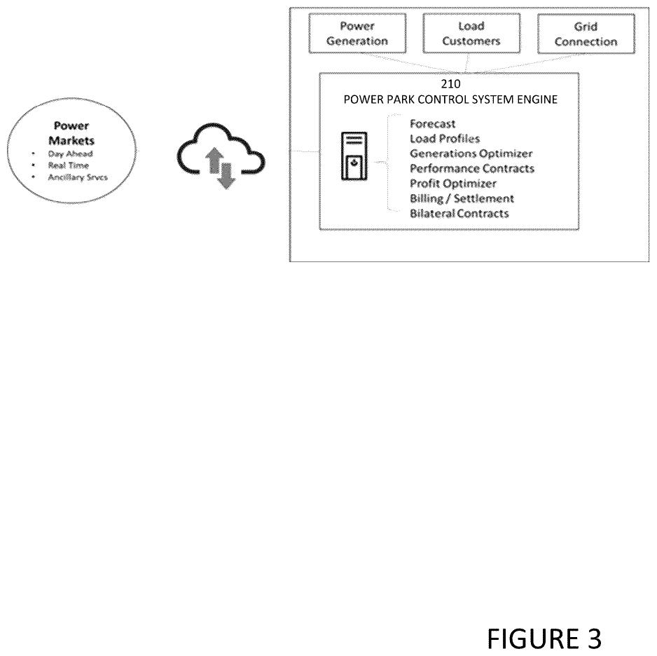

Turning to FIG. 3, FIG. 3 is a simplified block diagram illustrating example details of a particular non-limiting illustrative example of the power park control system engine 210. The power park control system engine 210 can be configured to automatically (e.g., without direct user actions) determine the amount of power and control the flow of power from various generations sources, including the electrical power grid, based on energy market prices (including natural gas and oil market prices as well as renewable energy prices), generation of carbon credits, and other factors to the plurality of loads to meet certain performance, economic, environmental criteria, etc. The power park control system engine 210 is configured to receive energy market data and performance contract parameters using the communication engine 208. Where in some embodiments, performance contracts may specify reliability, carbon intensity, load profiles, power frequency range and response, and other parameters. Based on this information, the power park control system engine 210 can optimize the energy distribution within the power park 100 (e.g., data centers, power-to-liquids) or determines the optimal amount of energy to resell into the market from various generation sources. In such a way, power park 100 could optimize and distribute power in a multitude of directions.

In some embodiments, the power park control system engine 210 as shown in FIG. 3 may receive various inputs and generate various outputs to manage energy distribution within the power park 100. Inputs to the power park control system engine 210 may include energy market data received via the communication engine 208, performance contract parameters retrieved from the database storage 206, real-time operational data from the energy generation source 106 and optional energy storage device 108, load demand data from the plurality of loads 102 and complementary load(s) 104, and grid status information from the electrical grid interface 110. Based on these inputs, the power park control system engine 210 may generate outputs including control signals to the energy generation source 106 to adjust generation levels, control signals to the optional energy storage device 108 to charge or discharge, control signals to the electrical grid interface 110 to import or export power, and load management signals to the complementary load(s) 104 to increase or decrease consumption. FIG. 3 illustrates these data flows between the power park control system engine 210 and the various components of the power park 100, showing how the engine serves as a central decision-making component that coordinates the operation of the power park 100.

In some embodiments, the database storage 206 may store various types of data to facilitate power park operations. For example, the database storage 206 may store historical energy prices, including spot prices and futures prices for electricity, natural gas, and other energy commodities. The database storage 206 may also store historical and predicted load profiles for the plurality of loads 102 and complementary load(s) 104, weather data including historical weather patterns and weather forecasts relevant to renewable energy generation, carbon credit values and renewable energy credit values, performance contract parameters and compliance records, and operational data from the energy generation source 106 and optional energy storage device 108. In some examples, the database storage 206 may store machine learning model parameters and training data used by the power park control system engine 210 to optimize energy distribution decisions.

In some embodiments, the power park control system engine 210 may integrate with meteorological services to receive weather forecasting data that is used to predict renewable energy generation and optimize power park operations. Weather forecasting data may include short-term forecasts spanning hours to days ahead, which may be used for operational planning and energy market participation, and long-term forecasts spanning weeks to months ahead, which may be used for maintenance scheduling and capacity planning. For solar energy generation, weather forecasts may include predictions of solar irradiance, cloud cover, temperature, and other factors that affect photovoltaic panel output. For wind energy generation, weather forecasts may include predictions of wind speed, wind direction, air density, and turbulence that affect wind turbine output. The power park control system engine 210 may use weather forecasts to predict the expected output of the energy generation source 106 and to adjust energy procurement, storage, and distribution decisions accordingly. In some examples, machine learning models may be trained on historical weather data and corresponding generation data to improve the accuracy of generation forecasts. The database storage 206 may store historical weather data, weather forecasts, and forecast accuracy metrics to support continuous improvement of forecasting capabilities.

The communication engine 208 can be configured to facilitate data exchange between the control system 118 and various internal and external systems. In some embodiments, the communication engine 208 may utilize various communication protocols, including but not limited to TCP/IP for network communications, MODBUS or DNP3 for industrial control system communications, RESTful APIs for integration with energy market data providers, and secure communication protocols such as TLS/SSL for encrypted data transmission. The communication engine 208 may receive real-time energy market data from energy exchanges, weather data from meteorological services, grid status information from grid operators, and operational data from the various components of the power park 100. The communication engine 208 may also transmit control signals to the energy generation source 106, the optional energy storage device 108, and the electrical grid interface 110 to implement power distribution decisions made by the power park control system engine 210.

The one or more processors 202 may be configured to execute instructions stored in the memory 204 to implement the functionality of the power park control system engine 210. In some embodiments, the processors 202 may include general-purpose processors, digital signal processors, graphics processing units, or specialized processors optimized for machine learning inference. The processors 202 may interact with the memory 204 to load and execute software modules, with the database storage 206 to retrieve and store operational data, and with the communication engine 208 to receive input data and transmit control signals. In some examples, the processors 202 may execute decision-making algorithms that evaluate multiple factors including current energy prices, predicted future energy prices, current and predicted load demands, available generation capacity, energy storage state of charge, carbon intensity targets, and performance contract requirements to determine optimal power distribution within the power park 100.

In other embodiments, additional data and information can be pulled/fed into the power park control system engine 210 that provides data and information on grid connection and congestion, different load customers, current and futures power prices, and energy resource and product prices. These can be factored into how to optimize system operations, environmental, as well as economic factors.

In some embodiments, the complementary load(s) 104 may differ from the plurality of loads 102 in their operational flexibility and their ability to generate value from excess energy. While the plurality of loads 102, such as datacenters, may require consistent, reliable power with minimal interruption, the complementary load(s) 104 may be configured to operate flexibly based on energy availability and pricing conditions. For example, the complementary load(s) 104 may increase consumption when renewable energy generation is high and electricity prices are low, and decrease consumption or even generate power when electricity prices are high or renewable generation is limited.

In some examples, the complementary load(s) 104 may include power-to-liquids processes such as hydrogen production via electrolysis, synthetic fuel production, ammonia synthesis, or methanol production. Hydrogen production via electrolysis may utilize excess renewable electricity to split water into hydrogen and oxygen, with the hydrogen being stored, sold, or used in fuel cells to generate electricity when needed. Synthetic fuel production may combine hydrogen with captured carbon dioxide to produce liquid fuels that can be stored, transported, and sold. These power-to-liquids processes may provide a mechanism for storing excess renewable energy in chemical form and generating revenue from energy that might otherwise be curtailed.

Fuel cells within the complementary load(s) 104 may integrate bidirectionally with the power park 100. In some embodiments, fuel cells may consume hydrogen or other fuels to generate electricity when electricity prices are high or when additional power is needed to meet load demands or performance contract requirements. Conversely, when electricity prices are low or renewable generation exceeds demand, electrolyzers may consume electricity to produce hydrogen that can be stored for later use in the fuel cells. This bidirectional capability may provide the power park 100 with additional flexibility in managing energy flows and optimizing economic returns.

The economic rationale for including complementary load(s) 104 in the power park 100 may include several factors. Complementary load(s) 104 may absorb excess renewable generation that might otherwise be curtailed, thereby increasing the utilization and economic value of renewable energy assets. Complementary load(s) 104 may also provide demand flexibility that can be used to balance intermittent renewable generation, reducing the need for grid imports or energy storage. Additionally, complementary load(s) 104 may generate products such as hydrogen, synthetic fuels, or electricity that can be sold to generate additional revenue streams for the power park 100.

In some embodiments, carbon credits and renewable energy credits may be generated, tracked, and utilized within the power park 100. Carbon credits may represent verified reductions in greenhouse gas emissions, such as carbon dioxide or methane, and may be generated when the power park 100 reduces emissions below a baseline level or captures and sequesters carbon dioxide using the CO₂ pipeline 116. Carbon credits may also be referred to as carbon offsets and may be measured in metric tons of carbon dioxide equivalent. Renewable energy credits, also known as renewable energy certificates (RECs), may represent the environmental attributes associated with electricity generated from renewable energy sources such as solar or wind. Each renewable energy credit may represent one megawatt-hour of renewable electricity generated and delivered to the grid. The power park control system engine 210 may monitor the generation of carbon credits and renewable energy credits based on the energy sources used and the carbon intensity of the power supplied to the plurality of loads 102. In some examples, carbon credits and renewable energy credits may be traded on various markets, retired to meet sustainability commitments, or bundled with power sales to provide verified low-carbon energy to customers. The database storage 206 may store records of carbon credits and renewable energy credits generated, traded, and retired by the power park 100.

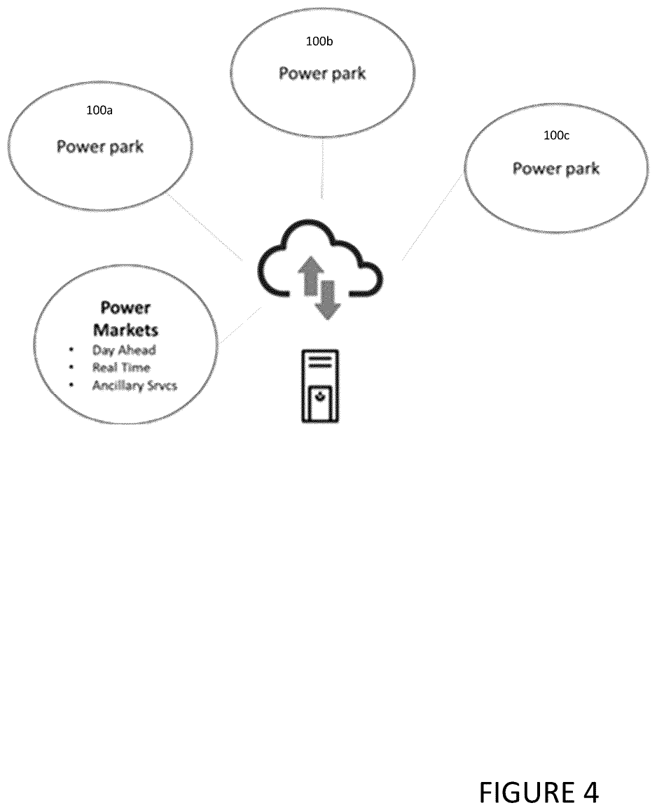

Turning to FIG. 4, FIG. 4 is a simplified block diagram illustrating example details of a particular non-limiting illustrative example of implementing a plurality of power parks 100. As illustrated in FIG. 4, a plurality of power parks (e.g., power parks 100a-100c), could also be networked and register new devices/entities. In such an approach, connection and centralized intelligence could be provided to improve grid stability, power prices, energy resource fuel costs, types of power generation, carbon intensity, power to liquid product value, electrolyzer/fuel cell operations, and datacenter operations. Each of the power parks 100a-100c may establish power purchase agreements with each other so excess power from one park may be sold through bilateral contracts to another power park.

In some embodiments, FIG. 4 illustrates the connections and communication links between the plurality of power parks 100a-100c. The power parks 100a-100c may be connected via communication networks that enable data exchange and coordination between the parks. FIG. 4 shows a central coordination system that communicates with each of the power parks 100a-100c to aggregate data, identify optimization opportunities, and coordinate responses to grid events or market conditions. FIG. 4 may also illustrate power flow connections between the power parks 100a-100c through the electrical grid or through direct interconnections, enabling the transfer of excess power from one park to another pursuant to bilateral contracts or power purchase agreements. The visual representation in FIG. 4 may depict the networked architecture that enables the plurality of power parks 100a-100c to operate as a coordinated system rather than as isolated installations.

In some embodiments, the performance contract parameters received by the power park control system engine 210 may include specific reliability metrics. Reliability metrics may include uptime percentage requirements, such as 99.9% or 99.99% availability, response time requirements for power delivery, power quality parameters such as voltage and frequency stability, and maximum allowable duration of power interruptions. The power park control system engine 210 may continuously monitor these reliability metrics and adjust power distribution to maintain compliance with the performance contract requirements.

Carbon intensity may be calculated and monitored by the power park control system engine 210 based on the sources of energy used to supply the plurality of loads 102. In some examples, carbon intensity may be expressed as grams of carbon dioxide equivalent per kilowatt-hour (gCO₂e/kWh) and may be calculated based on the mix of energy sources supplying the power park 100 at any given time. The power park control system engine 210 may track carbon intensity in real-time and may adjust the energy source mix to meet carbon intensity targets specified in performance contracts. For example, the power park control system engine 210 may increase the proportion of renewable energy or energy from low-carbon sources when carbon intensity targets are at risk of being exceeded.

Load profile parameters in the performance contracts may specify the expected power consumption patterns of the plurality of loads 102. In some embodiments, load profile parameters may include peak power demand, average power demand, load ramp rates, and time-of-day consumption patterns. The power park control system engine 210 may use these load profile parameters to predict future energy requirements and to optimize energy generation, storage, and procurement decisions accordingly.

In some examples, the power park control system engine 210 may implement fallback procedures when performance contract parameters cannot be met. Fallback procedures may include drawing additional power from the electrical grid interface 110, activating backup generation sources, reducing power to non-critical or flexible loads such as the complementary load(s) 104, or discharging the optional energy storage device 108. The power park control system engine 210 may prioritize maintaining power to critical loads such as datacenters while implementing load shedding or demand response measures for flexible loads. In some embodiments, the power park control system engine 210 may also generate alerts or notifications when performance contract parameters are at risk of being violated, allowing for manual intervention if necessary.

In some embodiments, the plurality of power parks 100a-100c may be networked using various networking architectures. For example, the power parks may be connected using a hub-and-spoke architecture in which a central coordination system communicates with each individual power park, or a mesh architecture in which each power park communicates directly with other power parks. In some examples, a hybrid architecture may be used in which power parks communicate with both a central coordination system and directly with neighboring power parks. The networking architecture may be selected based on factors such as geographic distribution of the power parks, communication infrastructure availability, and desired levels of redundancy and resilience.

Centralized intelligence may coordinate operations between the plurality of power parks 100a-100c to optimize overall system performance. In some embodiments, the centralized intelligence may aggregate data from each power park, including current generation capacity, load demands, energy storage levels, and local energy prices. Based on this aggregated data, the centralized intelligence may identify opportunities for energy sharing between power parks, coordinate responses to grid events or price signals, and optimize the overall carbon intensity and economic performance of the networked power parks. The centralized intelligence may also facilitate the registration of new devices or entities within the network and manage authentication and authorization for inter-park communications.

Data exchange between the plurality of power parks 100a-100c may utilize various protocols and data formats. In some examples, data exchange may include real-time operational data such as current generation, load, and storage levels, forecast data such as predicted generation and load for future time periods, market data such as current and predicted energy prices, and transactional data related to power purchase agreements and bilateral contracts. The data exchange protocols may include security measures such as encryption, authentication, and access controls to protect sensitive operational and commercial data.

In some embodiments, the data exchange between the plurality of power parks 100a-100c may implement comprehensive cybersecurity measures to protect critical infrastructure. Cybersecurity measures may include network segmentation to isolate operational technology networks from information technology networks and from external networks, reducing the attack surface and limiting the potential impact of security breaches. Intrusion detection systems may monitor network traffic for suspicious activity and generate alerts when potential security threats are detected. Secure communication protocols such as TLS/SSL may encrypt data in transit to prevent eavesdropping and tampering. Access control mechanisms may include multi-factor authentication, role-based access controls, and least-privilege principles to ensure that only authorized personnel can access sensitive systems and data. Audit logging may record all access attempts, configuration changes, and operational commands to support forensic analysis and compliance verification. The power park control system engine 210 may comply with critical infrastructure protection standards such as NERC CIP (North American Electric Reliability Corporation Critical Infrastructure Protection) standards, which specify cybersecurity requirements for bulk electric system assets. Incident response procedures may be established to detect, respond to, and recover from cybersecurity incidents while maintaining the reliability of power park operations.

Bilateral contracts between the plurality of power parks 100a-100c may be structured in various ways. In some embodiments, bilateral contracts may specify fixed quantities of power to be exchanged at predetermined prices, or may specify flexible arrangements in which power is exchanged based on real-time availability and pricing conditions. The power park control system engine 210 of each power park may be configured to automatically execute bilateral contracts by adjusting power flows through the electrical grid interface 110 based on the contract terms and current operational conditions. In some examples, smart contracts or other automated execution mechanisms may be used to facilitate the execution of bilateral contracts between power parks.

In some embodiments, smart contracts may be implemented using blockchain or distributed ledger technology to facilitate automated execution of bilateral contracts between the plurality of power parks 100a-100c. Smart contracts may be self-executing contracts with the terms of the agreement written directly into code, such that the contract automatically executes when predefined conditions are met. For example, a smart contract between two power parks may specify that power will be transferred from one park to another when the price differential between the parks exceeds a threshold value, or when one park has excess generation capacity above a specified level. The smart contract may automatically trigger the power transfer, record the transaction on the distributed ledger, and initiate settlement and payment between the parties without requiring manual intervention. Smart contracts may provide benefits including transparency, as all parties can view the contract terms and execution history on the distributed ledger, auditability, as the transaction history is immutable and verifiable, and efficiency, as the automated execution reduces transaction costs and delays. The power park control system engine 210 may interface with smart contract platforms to monitor contract conditions, trigger contract execution, and record contract performance.

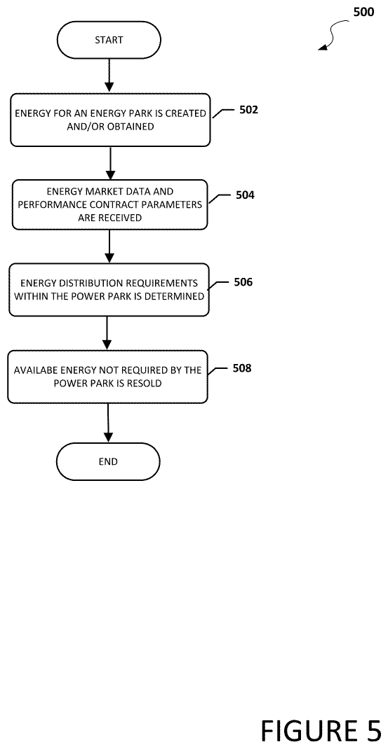

Turning to FIG. 5, FIG. 5 is an example flowchart illustrating possible operations of a flow 500 that may be associated with potential operations to help enable the power park, in accordance with an embodiment of the present disclosure. At 502, energy for an energy park is created and/or obtained. At 504, energy market data and performance contract parameters are received. At 506, energy distribution requirements within the power park are determined. At 508, available energy not required by the power park is resold.

In some embodiments, the operation at 502 of creating energy in a power park and/or receiving energy by the power park may include several sub-operations. For example, the power park control system engine 210 may monitor the operational status of the energy generation source 106, including current generation capacity, fuel availability, and maintenance status. The power park control system engine 210 may also monitor the state of charge of the optional energy storage device 108 and the availability of power from the electrical grid interface 110. Based on this information, the power park control system engine 210 may determine the optimal mix of energy sources to meet current and anticipated load demands.

The operation at 504 of receiving energy market data and performance contract parameters may include receiving data from multiple sources. In some examples, energy market data may be received from energy exchanges, grid operators, weather services, and other data providers via the communication engine 208. Performance contract parameters may be retrieved from the database storage 206 or received from contract management systems. The power park control system engine 210 may validate and preprocess the received data before using it in energy distribution decisions.

The operation at 506 of determining energy distribution requirements within the power park may include evaluating multiple factors and making decisions based on optimization criteria. In some embodiments, the power park control system engine 210 may evaluate current and predicted load demands from the plurality of loads 102 and complementary load(s) 104, current and predicted energy generation from the energy generation source 106, current state of charge and available capacity of the optional energy storage device 108, current and predicted energy prices from the energy market data, carbon intensity targets and current carbon intensity levels, and performance contract requirements including reliability and power quality parameters. Based on this evaluation, the power park control system engine 210 may determine the optimal distribution of energy to each load, the optimal charging or discharging of the energy storage device, and the optimal import or export of energy through the electrical grid interface 110.

In some examples, the operation at 506 may include decision points and conditional logic. For example, if current renewable generation exceeds current load demand, the power park control system engine 210 may decide to charge the optional energy storage device 108, increase consumption by the complementary load(s) 104, or export excess energy through the electrical grid interface 110, depending on current energy prices and storage capacity. If current load demand exceeds current generation capacity, the power park control system engine 210 may decide to discharge the optional energy storage device 108, reduce consumption by flexible loads, or import energy through the electrical grid interface 110, depending on energy prices and performance contract requirements.

The operation at 508 of selling available energy not required by the power park may include determining the quantity and timing of energy sales. In some embodiments, the power park control system engine 210 may evaluate current and predicted energy prices to determine optimal timing for energy sales. The power park control system engine 210 may also consider bilateral contracts with other power parks, grid operator requests for ancillary services, and regulatory requirements when determining energy sales. Energy sales may be executed through the electrical grid interface 110 and may be settled through energy market mechanisms or bilateral contract arrangements.

In some embodiments, the flow 500 may include feedback loops for continuous monitoring and adjustment. For example, after determining energy distribution requirements at 506 and implementing the distribution, the power park control system engine 210 may continuously monitor actual energy flows, load demands, and generation levels. If actual conditions deviate from predicted conditions, the power park control system engine 210 may adjust the energy distribution in real-time to maintain compliance with performance contract requirements and optimize economic performance. This continuous monitoring and adjustment may occur on timescales ranging from seconds to hours depending on the specific operational requirements.

The flow 500 may also include error handling and contingency operations. In some examples, if a component of the power park 100 experiences a fault or failure, the power park control system engine 210 may implement contingency procedures to maintain power to critical loads. Contingency procedures may include activating backup generation sources, importing additional power from the electrical grid interface 110, shedding non-critical loads, or requesting emergency power from other networked power parks. The power park control system engine 210 may also log error conditions and generate alerts for maintenance personnel.

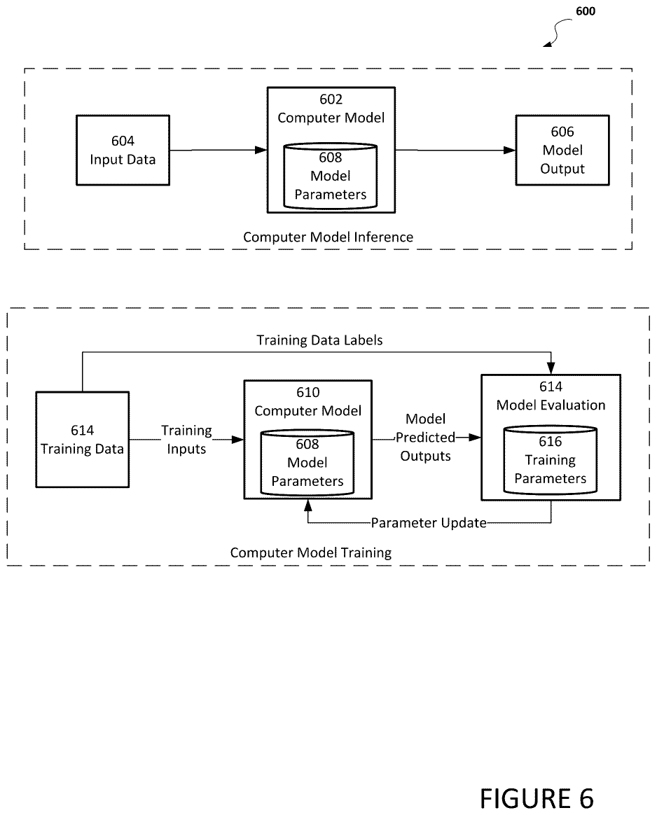

Turning to FIG. 6, FIG. 6 illustrates example computer model inference and computer model training 600. Computer model inference refers to the application of a computer model 602 to a set of input data 604 to generate an output or model output 606. The computer model 602 determines the model output 606 based on parameters of the model, also referred to as model parameters 608. The parameters of the model may be determined based on a training process that finds an optimization of the model parameters 608, typically using training data and desired outputs of the model for the respective training data as discussed below. The output (e.g., the determined energy distribution within the power park and if power can be resold) of the computer model 602 may be referred to as an “inference” because it is a predictive value based on the input data 604 and based on previous example data used in the model training.

The input data 604 and the model output 606 vary according to the particular use case. For example, to determine energy distribution within the power park and if power can be resold, the input data 604 may be the energy requirements of the power park and energy market data and performance contract parameters and the output or “inference” may be a score or some other indication of the energy distribution within the power park and if power can be resold.

In an illustrative example of classifications of portions of an image, computer vision and image analysis, the input data 604 may be an image having a particular resolution, such as 75×75 pixels, or a point cloud describing a volume. In other applications, the input data 604 may include a vector, such as a sparse vector, representing information about an object. For example, in recommendation systems, such a vector may represent user-object interactions, such that the sparse vector indicates individual items positively rated by a user. In addition, the input data 604 may be a processed version of another type of input object, for example representing various features of the input object or representing preprocessing of the input object before input of the object to the computer model 602. As one example, a 1024×1024 resolution image may be processed and subdivided into individual image portions of 64×64, which are the input data 604 processed by the computer model 602. As another example, the input object, such as a sparse vector discussed above, may be processed to determine an embedding or another compact representation of the input object that may be used to represent the object as the input data 604 in the computer model 602.

Such additional processing for input objects may themselves be learned representations of data, such that another computer model processes the input objects to generate an output that is used as the input data 604 for the computer model 602. Although not further discussed here, such further computer models may be independently or jointly trained with the computer model 602. As noted above, the model output 606 may depend on the particular application of the computer model 602, for example, the determined energy distribution within the power park and if power can be resold.

The computer model 602 includes various model parameters 608, as noted above, that describe the characteristics and functions that generate the model output 606 from the input data 604. In particular, the model parameters 608 may include a model structure, model weights, and a model execution environment. The model structure may include, for example, the particular type of computer model 602 and its structure and organization. For example, the model structure may designate a neural network, which may be comprised of multiple layers, and the model parameters 608 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 602 processes the input data 604 to the model output 606. Each portion or layer of the computer model 602 may have such weights. For example, weights may be used to determine values for processing inputs to determine outputs at a particular portion of a model. Stated another way, for example, model weights may describe how to combine or manipulate values of the input data 604 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer. For example, one or more of the performance contract parameters may be weighed more than one or more energy market data.

The model execution parameters represent parameters describing the execution conditions for the model. In particular, aspects of the model may be implemented on various types of hardware or circuitry for executing the computer model 602. For example, portions of the model may be implemented in various types of circuitry, such as general-purpose circuitry (e.g., a general CPU), circuitry specialized for certain functions (e.g., a GPU or programmable Multiply-and-Accumulate circuit) or circuitry specially designed for the particular computer model application. In some configurations, different portions of the computer model 602 may be implemented on different types of circuitries. As discussed below, training of the model may include optimizing the types of hardware used for certain aspects of the computer model 602 (e.g., co-trained), or may be determined after other parameters for the computer model 602 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 608 for the computer model 610. During training, the model parameters 608 are optimized to “learn” values of the model parameters (such as individual weights, activation values, model execution environment, etc.), that improve the model parameters 608 based on an optimization function that seeks to improve a cost function (also sometimes termed a loss function). Before training, the computer model 610 has model parameters 608 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 612 includes a data set to be used for training the computer model 610. The data set varies according to the particular application and purpose of the computer model 610. In supervised learning tasks, the training data 612 typically includes a set of training data labels that describe the training data 612 and the desired output of the model relative to the training data 612. For example, to determine energy distribution within the power park and if power can be resold, the training data 612 may include previously collected data related to the determined energy distribution within a power park and if power was resold c. For this task, the training data 612 may include energy market data and performance contract parameters related to the power park, such that the computer model 610 is intended to learn to also label the same type of data as being related to the determined energy distribution within the power park and if power can be resold.

To train the computer model 610, a training module (not shown) applies the training inputs to the computer model 610 to determine the outputs predicted by the model for the given training inputs. The training module, though not shown, is a computing module used for performing the training of the computer model 610 by executing the computer model 610 according to its inputs and outputs given the model's parameters and modifying the model parameters based on the results. The training module may apply the actual execution environment of the computer model 610, or may simulate the results of the execution environment, for example to estimate the performance, runtime, memory, or circuit area (e.g., if specialized hardware is used) of the computer model 610. The training module, along with the training data 612 and model evaluation, may be instantiated in software and/or hardware by one or more processing devices. In various examples, the training process may also be performed by multiple computing systems in conjunction with one another, such as distributed/cloud computing systems. In some examples the training of the computer module 610 may be different if the computer model 610 is a large language model (LLM) used for automated message responses as compared to being used to determine energy distribution within the power park and if power can be resold. A large language model is used for language-based tasks, whereas the general AI model or computer model can be used for a variety of other tasks, including to determine energy distribution within the power park and if power can be resold.

After processing the training inputs according to the current model parameters for the computer model 610, the model's predicted outputs are evaluated and the computer model 610 is evaluated with respect to the cost function and optimized using an optimization function of the training model. Depending on the optimization function, particular training process and training parameters 616 after the model evaluation are updated to improve the optimization function of the computer model 610. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 610 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 610 structure and execution environment (e.g., to evaluate or modify these model parameters).

After determining results of the cost function, the optimization function determines a modification of the model parameters to improve the cost function for the training data 612. Many such optimization functions are known to one skilled in the art. Many such approaches differentiate the cost function with respect to the parameters of the model and determine modifications to the model parameters that thus improves the cost function. The parameters for the optimization function, including algorithms for modifying the model parameters are the training parameters 616 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 612 is batched and the parameter updates are iteratively applied to batches of the training data 612. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 612 available or the incremental improvements in model parameters are below a threshold (e.g., additional training data 612 no longer continues to improve the model parameters). Additional training parameters 616 may describe the batch size for the training data 612, a portion of training data 612 to use as validation data, the step size of parameter updates, a learning rate of the model, and so forth. Additional techniques may also be used to determine global optimums or address nondifferentiable model parameter spaces.

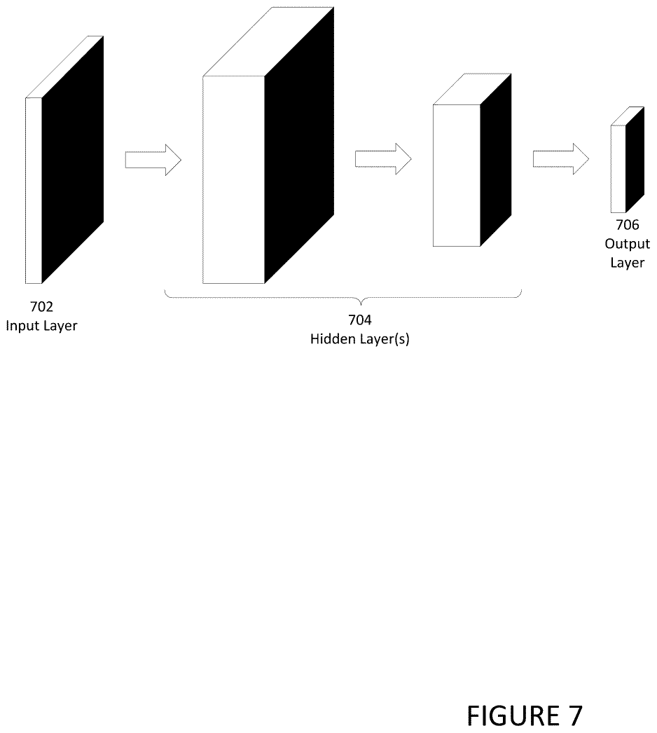

Turning to FIG. 7, FIG. 7 illustrates an example neural network architecture. In general, a neural network includes an input layer 702, one or more hidden layers 704, and an output layer 706. The values for data in each layer of the network are generally determined based on one or more prior layers of the network. Each layer of a network generates a set of values, termed “activations” that represent the output values of that layer of a network and may be the input to the next layer of the network. For the input layer 702, the activations are typically the values of the input data, although the input layer 702 may represent input data as modified through one or more transformations to generate representations of the input data. For example, in recommendation systems, interactions between users and objects may be represented as a sparse matrix. Individual users or objects may then be represented as an input layer 702 as a transformation of the data in the sparse matrix relevant to that user or object. The neural network may also receive the output of another computer model (or several), as its input layer 702, such that the input layer 702 of the neural network shown in FIG. 7 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 706 of the network.

Each layer of the neural network typically represents its output activations (i.e., also termed its outputs) in a matrix, which may be 1, 2, 3, or n-dimensional according to the particular structure of the network. As shown in FIG. 7, the dimensionality of each layer may differ according to the design of each layer. The dimensionality of the output layer 706 depends on the characteristics of the prediction made by the model. For example, a computer model for multi-object classification may generate an output layer 706 having a one-dimensional array in which each position in the array represents the likelihood of a different classification for the input layer 702. In another example for classification of portions of an image, the input layer 702 may be an image having a resolution, such as 512×512, and the output layer may be a 512×512×n matrix in which the output layer 706 provides n classification predictions for each of the input pixels, such that the corresponding position of each pixel in the input layer 702 in the output layer 706 is an n-dimensional array corresponding to the classification predictions for that pixel.

The hidden layers 704 provide output activations that variously characterize the input layer 702 in various ways that assist in effectively generating the output layer 706. The hidden layers thus may be considered to provide additional features or characteristics of the input layer 702. Though two hidden layers are shown in FIG. 7, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer are typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 706. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 702 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable the power park in that any suitable arrangements, chronologies, configurations, and timing mechanisms may be provided without departing from the teachings of the present disclosure.

Note that embodiments of the plurality of loads 102, the energy generation source 106, the optional energy storage device 108, the electrical grid interface 110, and the control system 118, may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces may include physical ports (e.g., Ethernet, USB, HDMI, etc.), interfaces for wired and wireless internal subsystems, and the like. Similarly, each of the plurality of loads 102, the energy generation source 106, the optional energy storage device 108, the electrical grid interface 110, and the control system 118 can also include suitable interfaces for receiving, transmitting, and/or otherwise communicating data or information in a network environment.

The plurality of loads 102, the energy generation source 106, the optional energy storage device 108, the electrical grid interface 110, and the control system 118 and other associated or integrated components can include one or more memory elements for storing information to be used in achieving operations associated with the power park, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling the power park, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the implementation of the power park described in this Specification. Regarding a physical implementation of the control system 118 and its associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable the power park and their teachings are readily scalable and can accommodate a large number of components, as well as more complicated/sophisticated arrangements and configurations. Accordingly, the examples provided should not limit the scope or inhibit the broad teachings of the system, apparatus, and method to enable the power park and as potentially applied to a myriad of other architectures.

It is also important to note that the operations in the preceding flow diagram (i.e., FIG. 5) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
creating energy in a power park and/or receiving energy by the power park;
receiving energy market data and performance contract parameters;
determining energy distribution requirements within the power park; and
distributing or selling available energy not required by the power park.

2. The method of claim 1, wherein creating energy in the power park comprises generating energy using at least one of: a solar energy source, a wind energy source, a natural gas energy source with carbon capture and sequestration, a small modular nuclear reactor, or a geothermal power plant.

3. The method of claim 1, wherein the power park comprises a plurality of loads including at least one of: a datacenter, a bitcoin mining operation, a power-to-liquid industrial complex, an electrolyzer, or a fuel cell.

4. The method of claim 1, wherein the power park comprises at least one complementary load configured to generate power for sale or usage within the power park or outside the power park through an electrical grid interface.

5. The method of claim 1, wherein determining energy distribution requirements within the power park comprises using a computer model to optimize energy distribution based on the energy market data and the performance contract parameters.

6. The method of claim 1, further comprising monitoring at least one of carbon credits or renewable energy credits.

7. The method of claim 1, wherein determining energy distribution requirements comprises receiving weather forecasting data and predicting renewable energy generation based on the weather forecasting data.

8. The method of claim 1, further comprising storing energy in an energy storage device.

9. The method of claim 1, further comprising networking the power park with a plurality of other power parks.

10. The method of claim 1, further comprising:
providing ancillary services to an external electrical power grid through an electrical grid interface, wherein the ancillary services include at least one of: frequency regulation, spinning reserves, voltage support, or black start capability.

11. A power park system, comprising:
a plurality of loads;
an energy generation source;
an electrical grid interface;
at least one processor;
memory; and
a power park control system engine configured to:
receive energy market data and performance contract parameters;
determine energy distribution requirements within the power park; and
distribute or sell available energy not required by the power park.

12. The power park system of claim 11, wherein the energy generation source comprises at least one of: a solar energy source, a wind energy source, a natural gas energy source with carbon capture and sequestration, a small modular nuclear reactor, or a geothermal power plant.

13. The power park system of claim 11, wherein the plurality of loads comprises at least one of: a datacenter, a bitcoin mining operation, a power-to-liquid industrial complex, an electrolyzer, or a fuel cell.

14. The power park system of claim 11, wherein the power park control system engine implements cybersecurity measures including at least one of: network segmentation, intrusion detection, multi-factor authentication, or audit logging.

15. The power park system of claim 11, wherein the performance contract parameters comprise at least one of: reliability parameters, carbon intensity parameters, load profile parameters, or power frequency range parameters.

16. The power park system of claim 11, further comprising a control system including database storage, a communication engine, and the power park control system engine, wherein the database storage is configured to store historical energy prices, load profiles, weather data, and carbon credit values.

17. A non-transitory computer-readable medium storing instructions that, when executed by at least one processor, cause the at least one processor to:
receive energy market data and performance contract parameters for a power park;
determine energy distribution requirements within the power park based on the energy market data and the performance contract parameters; and
determine available energy not required by the power park for distributing or selling.

18. The non-transitory computer-readable medium of claim 17, wherein the instructions further cause the at least one processor to use a machine learning model to optimize energy distribution within the power park.

19. The non-transitory computer-readable medium of claim 17, wherein the instructions further cause the at least one processor to execute smart contracts to automatically facilitate bilateral contracts between the power park and a plurality of other power parks based on predefined conditions.

20. The non-transitory computer-readable medium of claim 17, wherein the instructions further cause the at least one processor to coordinate energy distribution with a plurality of networked power parks.
